(19) United States
(12) Patent Application Publication
(10) Pub. No.: US 2025/0322389 A1
(43) Pub. Date: Oct. 16, 2025

(54) ARTIFICIAL INTELLIGENCE POWERED HOLISTIC DIGITAL BANKING

(71) Applicant: JP Morgan Chase Bank, N.A., New York, NY (US)

(72) Inventors: Nishant Kumaria, Bengaluru (IN); Krishnakumar Mahalingam, Bangalore (IN); Niharika Sharma, Bengaluru (IN)

(73) Assignee: JP Morgan Chase Bank, N.A., New York, NY (US)

(21) Appl. No.: 19/072,756

(22) Filed: Mar. 6, 2025

(30) Foreign Application Priority Data
Mar. 1, 2024 (IN) 202411015372

(51) Int. Cl. G06Q 20/38

(52) U.S. Cl. CPC G06Q 20/3823

(57) ABSTRACT

Provided is a method for implementation of an application running on a computer having a processor and a memory or a cloud infrastructure, receiving a request from a user, via a gateway manager, to initiate a future payment transaction in accordance with a selected one of a plurality of payment transaction types. The method also includes comparing, via an allocation engine, the requested future payment transaction with patterns derived from an analysis of stored previous payment transactions associated with the user, wherein the patterns represent an association of each of the payment transaction types with one of a plurality of different types of vendors from the stored previous payment transactions. A payment transaction type is automatically selected for the future payment transactions based on the comparison.

### CROSS-REFERENCE TO RELATED APPLICATIONS

This application claims benefit to Indian Provisional Application No. 202411015372, filed Mar. 1, 2024, the disclosure of which is incorporated herein in its entirety, by reference.

### FIELD OF TECHNOLOGY

The present disclosure generally relates to the use of artificial intelligence (AI), machine learning (ML), and Cloud Infrastructure to facilitate payment transactions.

### BACKGROUND

Traditional payment systems, while functional, have been designed around static, linear processes that fail to meet the evolving demands of the modern digital economy. These systems typically rely on predefined methods, offering limited flexibility for users to manage diverse financial instruments effectively. They lack the capability to adapt dynamically to user preferences, transaction contexts, and evolving security threats, creating inefficiencies and vulnerabilities in financial management.

In conventional payment ecosystems, users are burdened with remembering multiple passwords, managing daily transaction limits, and manually selecting payment methods for different transactions. This fragmented approach not only diminishes user convenience but also increases the risk of errors and security breaches. Existing solutions, such as digital wallets and banking apps, provide basic functionalities like fund transfers and contactless payments but fall short in offering comprehensive customization, intelligent automation, and real-time risk assessment.

Moreover, while some modern payment platforms incorporate rudimentary AI features, such as fraud detection algorithms, they lack holistic, AI-driven orchestration that can intelligently manage and optimize transactions across multiple financial instruments. These systems do not fully leverage user data to provide personalized financial insights or dynamic security protocols tailored to transaction-specific risks.

The growing complexity of financial transactions, like the need to capitalize on real-time offers and discounts, further exposes the limitations of traditional payment systems. Users often find themselves juggling multiple applications, each with their own set of rules, authentication methods, and user interfaces, leading to a disjointed and inefficient payment experience.

### SUMMARY

Given the aforementioned deficiencies, the current imperative involves the development of an all-encompassing solution that ensures a seamless payment experience, incorporates multi-factor authentication, delivers a best-in-class user interface, upholds high reliability, and adheres to world-class standards. The objective is to introduce an innovative application that integrates seamlessly with existing systems and methodologies, offering a state-of-the-art payment experience without necessitating customers to migrate from their current subscriptions.

This disclosure addresses these challenges by introducing an advanced, AI-powered digital banking application designed to seamlessly integrate diverse financial instruments within a unified platform. The invention not only empowers users to define dynamic payment rules and preferences but also leverages sophisticated AI algorithms to optimize transaction decisions and execute payments securely and efficiently. By bridging the gap between user-defined controls and intelligent automation, this innovation sets a new benchmark for personalized, secure, and efficient financial management in the digital age.

In accordance with the present disclosure, one embodiment involves an internet-based payment transaction initiated by a user through their mobile or electronic device. This transaction may encompass various forms, such as a bank transfer, a barcode-based payment request, or a payment initiated through a POS device. Instead of relying on individual payment instruments, the user initiates the process through a unified application. Upon receiving the payment request, the application authenticates the user, gathers data on previous transactions, exchanges tokens for transaction security, and activates the payment gateway manager. This approach relieves the user from the burden of deciding which payment instrument to use for a specific transaction. The application automatically determines the most suitable instrument based on the rules of the allocation engine intelligently. Consequently, the user experiences a streamlined process, utilizing a single application for various transactions without the need to make payment instrument-related decisions.

A significant benefit of embodiments of the present disclosure is the introduction of a proximity payment system that leverages voice modulation recognition to enable customers to make payments through voice commands. By employing this voice-based payment system, customers can interact with their IoT devices effortlessly, eliminating the need for physical contact or manual input.

By way of example, in the rapidly evolving landscape of IoT based devices, various smart devices are interconnected to provide customers with a plethora of services and functionalities. One such service provides enhanced payment methods with the ability to make payments using IoT devices, which offers unparalleled convenience and accessibility. However, a challenge arises in situations where multiple IoT devices, that are capable of processing payments, are present around the customer. Accordingly, this challenge creates the need to select the most appropriate IoT device to facilitate payment processing.

One exemplary embodiment provides a voice-modulation based proximity payment system, offering secure inconvenient transactions within the IoT domain. In this example, by leveraging voice commands, with scoring mechanisms, customers can make payments effortlessly within their surrounding IoT domain. A redundancy feature ensures a seamless payment experience, providing customers with a reliable and efficient payment solution.

Other embodiments integrate IoT payment devices with various banks and payment gateways. This integration enables seamless fund transfers and offers OTP generation approaches. In this approach, data privacy is optimized by safeguarding customer data. The optimized approach includes biometrics and leverages the customer's transaction history, which protects against breaches and misuse.

The configuration step of the application helps the user curate a comprehensive banking profile, determining the prioritization of their payment instruments in a specified sequence. [The user establishes the security authentication protocols, defining the level of security required for using every payment instrument]. For instance, the user may stipulate that transactions under $10 require no security authentication for e-wallets, those up to $100 necessitate biometric authentication for credit cards, and any transaction exceeding $500 demands a combination of biometric verification and an OTP for all instruments. Methods and systems constructed in accordance with the aforementioned embodiments also enhance usability by providing a customer-friendly interface to offer a high level of personalization based on individual needs. Thus, transactions are securitized using reliable and accurate authentication (e.g., providing voice recognition, OTP, password and biometric authentication).

One embodiment includes a method for initiating future payment transactions, including receiving, via a gateway manager, requests from the user to make current payments to a plurality of vendor payment platforms in accordance with the behavior of the user and using AI, via an allocation engine, to dynamically evaluate the received requests, analyze the user's behavior, and recognize patterns responsive to the evaluation and analysis. The method also includes automatically selecting an optimal one of the plurality vendor payment platforms for future payments by the user in accordance with the evaluation, the analysis, and the recognized patterns.

The method of any preceding clause, wherein the behavior relates to at least one of selecting payment methods and selecting authentication methods.

The method of any preceding clause, wherein the payment methods include at least one of credit cards, e-wallets, bank transfers, and unified payment interfaces.

The method of any preceding clause, further comprising a security engine, the security engine configured to implement the authentication methods, dynamically adjust the authentication methods based on user-defined preferences, vary security levels, and adapt to transaction amounts;

The method of any preceding clause, wherein the security methods include at least one multifactor authentication, voice modulation recognition, and a one-time password.

The method of any preceding clause, wherein the gateway manager securely receives the requests from the user.

The method of any preceding clause, further comprising analyzing, via an intelligent data processing and analysis system, stored previous transactions associated with the user.

The method of any preceding clause, further comprising analyzing stored previous transactions associated with the user and identifying patterns for associating payment transaction types with different vendors.

The method of any preceding clause, further comprising creating, via a profiling system agent, personalized payment profiles.

The method of any preceding clause, further comprising executing transactions via a payment engine configured to operate in conjunction with a rules evaluator engine.

Yet another embodiment includes a banking system for initiating future payments from a user to a vendor, including a gateway manager configured for receiving requests from the user to make current payments to a plurality of vendor payment platforms in accordance with behavior of the user and an allocation engine configured to use AI to dynamically evaluate the received requests, analyze the user's behavior, and recognize patterns responsive to the evaluation and analysis, wherein an optimal one of the plurality vendor payment platforms is automatically selected for future payments by the user in accordance with the evaluating, the analysis, and the recognized patterns.

The banking system of any preceding clause, wherein the behavior relates to at least one of selecting payment methods and selecting authentication methods.

The banking system of any preceding clause, wherein the payment methods include at least one of credit cards, e-wallets, bank transfers, and unified payment interfaces.

The banking system of any preceding clause, further comprising a security engine, the security engine configured to implement the authentication methods, dynamically adjust the authentication methods based on user-defined preferences, vary security levels, and adapt to transaction amounts, wherein the security methods include at least one of multifactor authentication, voice modulation recognition, and a one-time password.

The banking system of any preceding clause, wherein the gateway manager securely receives the requests from the user.

The banking system of any preceding clause, further comprising an intelligent data processing and analysis system.

The banking system of any preceding clause, wherein the intelligent data processing and analysis system includes a data processing and analysis agent configured for analyzing stored previous transactions associated with the user, and identifying patterns associating payment transaction types with different vendors.

The banking system of any preceding clause, further comprising a profiling system agent enabling the user to create personalized payment profiles.

The banking system of any preceding clause, further comprising a payment engine configured to operate in conjunction with a rules evaluator engine to execute transactions.

Another embodiment includes a non-transitory computer-readable medium having instructions stored thereon, the instructions, when executed, cause a processor to perform a method including receiving, via a gateway manager, requests from the user to make current payments to a plurality of vendor payment platforms in accordance with behavior of the user, using AI, via an allocation engine, to dynamically evaluate the received requests, analyze the user's behavior, and recognize patterns responsive to the evaluation and analysis and automatically selecting an optimal one of the plurality vendor payment platforms for future payments by the user in accordance with the evaluating, the analysis, and the recognized patterns.

The non-transitory computer-readable medium any preceding clause, wherein the behavior relates to at least one of selecting payment methods and selecting authentication methods.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a conventional payment ecosystem.

FIG. 2 illustrates a holistic digital banking platform (HDBP) high level architecture constructed and arranged in accordance with embodiments of the present disclosure.

FIG. 3 provides a detailed high-level design (HLD) view of the HDBP depicted in FIG. 2.

FIG. 4 illustrates a block diagram view of an exemplary customer environment within which the HDBP of FIG. 3 may be implemented, in accordance with the embodiments.

FIG. 5 illustrates a sequence diagram of transactions within the environment of FIG. 4.

FIG. 6 illustrates an exemplary architecture upon which embodiments of the present disclosure may be practiced.

### DETAILED DESCRIPTION

This disclosure describes systems, apparatuses, and methods related to enhanced payment methods with the ability to make payments using mobile and electronic devices, which offers unparalleled convenience and accessibility.

In the following detailed description of the present disclosure, reference is made to the accompanying drawings that form a part hereof, and which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized, and that software, process, and other architectural changes may be made without departing from the scope of the present disclosure.

Embodiments of the present disclosure provide customizable profiles allowing customers to create payment profiles with rules for specific transactions. The customizable profiles grant customers control over payment methods and authentication. For example, multi-factor authentication may be implemented using voice recognition, OTP, and biometric data to enhance security and reduce the risk of unauthorized access.

In an embodiment of the present disclosure, an AI/ML-based dynamic payment allocation engine (DPAE) considers payment transaction requirements, available funds, and customer preferences to select an optimal payment method within various alternatives. Additionally, customers may create profiles for different transaction types (e.g., rent, bills, shopping) within the application. For each profile, customers may set rules for preferred payment methods (credit card, debit card, unified payment interface (UPI)), bank payments, and authentication methods, such as voice, OTP, biometrics, etc.

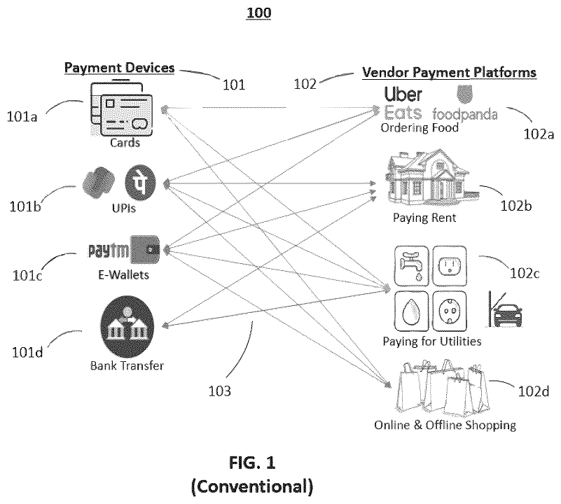

FIG. 1 illustrates a conventional payment ecosystem 100. The conventional payment ecosystem 100, for example, embodies the payment system deficiencies noted above. Among these deficiencies are inflexible payment methods, security shortcomings, and limited flexibility for personalized payment profiles and dynamic fund allocation, just to name a few.

The payment ecosystem 100 includes, for example, payment instruments 101 and vendor payment platforms 102. By way of example, the payment instruments 101 may also include credit cards 101a, UPIs 101b, E-wallets 101c, bank transfers 101d, each hosted by respective financial institutions and corresponding application programming interfaces (APIs). The vendor payment platforms 102, for example, may include food outlets 102a, rent/mortgage institutions 102b, utility companies 102c, and online shopping vendors 102d, etc. Each of the vendor payment platforms 102 is similarly supported by its own respective institution and corresponding API.

For example, the customer may be presented with a quick-response (QR) code representing an opportunity to make a purchase. The customer may have several credit/debit cards 101a and several E-wallets 101c and, as an example, may desire coffee from the food vendor 102a or desire to make a number of online shopping vendors 102d. After completing these purchases, the customer may desire to submit payment for their rent 102b.

If the customer attempts to use one of the credit cards 101a or one of the E-wallets 101c under the wrong circumstances, a transaction error could occur. For example, if one of the credit cards 101a is used to pay the rent/mortgage institutions 102b, the available credit or daily spending limit of the card may be exceeded. As a consequence, the customer's preferred credit card 101a may not be available for use at the time the customer attempts to use it.

In a different example, the customer may desire to use another one of the payment instruments, 101, for loyalty points or for discounts. The customer may additionally need to consider security issues. For example, there may be physical locations that may be sub-optimal for making bank transfers 101d, with respect to security. Even further, one of the credit cards 101a may have insufficient available spending room to complete payment, for example, of the rent/mortgage institutions 102b or the utility companies 102c. Thus, the customer has many issues to consider regarding the use of the conventional banking ecosystem 100.

To use the conventional payment ecosystem 100 more efficiently, the customer may manually create rules 103 (represented by connection lines) to guide which of the payment instruments 101 is optimal to pay specific ones of the vendor payment platforms 102. That is, rule 103 may help streamline factors the customer considers in deciding which of the credit cards 101a, the UPIs 101b, the E-wallets 101c, or the bank transfers 101d will be used in a particular moment to submit payments to the vendor payment platforms 102.

For example, the customer may manually define a rule indicating that if the purchase is around $100, the E-wallet 101c is the desired payment transaction instrument. If the purchase is more than $500, a different rule may indicate that one of the credit cards 101a should be used. Here, the customer must still decide which one of the credit cards 101a to use. Additionally, the customer may define a rule indicating that if the purchase is more than $1000, a bank transfer 101d should be used. Thus, each time the conventional banking ecosystem 100 is used, numerous burdensome decisions are required by the customer.

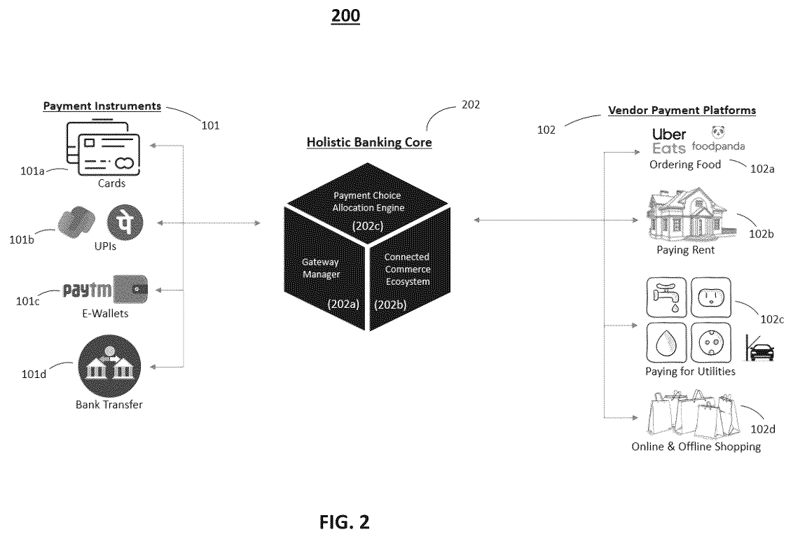

FIG. 2 illustrates an HDBP high-level architecture 200 constructed and arranged in accordance with embodiments. The HDBP high-level architecture 200 provides a holistic banking core (HBC) 202 that individually and uniquely connects each of the payment instruments 101 to each of the vendors 102, as discussed in greater detail below. In one or more illustrious embodiments, the HBC 202 may be a mobile application. Connection to and integration within the HBC 202 occurs securely through gateway manager 202a and is facilitated via the respective APIs (not shown) within a connected commerce ecosystem 202b.

The HBC 202 includes a payment choice allocation engine 202c that forms the connection between the respective payment instrument APIs and the vendor payment platform APIs, as noted above. More specifically, the allocation engine 202c uses AI and ML integration to recognize and analyze patterns in the customer's selection of specific payment instruments 101 (e.g., the cards 101a, the UPIs 101b, the E-wallets 101c, the bank transfers 101d, etc.) for paying vendors via the vendor payment platforms 102. Accordingly, the allocation engine 202c provides a better way of purchasing, and a better way of allocating the payment transactions for future purchases across the different payment instruments 101.

Consider the example of a customer paying monthly rent/mortgage to financial institutions 102b. The allocation engine 202c may analyze customer profile data (e.g., transactions volume, transaction rules) and correlate observation of a pattern, that the customer; chooses a specific payment instrument 101, such as the bank transfer 101d to pay a specific amount (e.g., the rent) at a specific time of the month. Accordingly, future rent payments will be submitted consistently with this analysis and choice of payment instruments 101.

In the embodiments, the customer's payment instruments 101 are seamlessly linked to the various vendor payment platforms 102, enabling the customer to effortlessly submit payments, using an automatically selected payment transaction instrument, to particular vendors.

In another example, the allocation engine 202c may note that a certain discount coupon is available when one of the customer's E-wallets 101c is chosen at a particular fuel station, or similar. While performing a payment, all transactions related to payment instruments 101, involving other financial institutions and vendor payment platforms 102, seamlessly traverse a unified path through the HBC 202. This journey is orchestrated through the allocation engine 202c, which executes smart rules to ensure a streamlined and efficient transaction process. This orchestrated flow, governed by smart rules, simplifies the challenges of the current ecosystem and offers enhanced user experience, overall efficiency, and greater transparency of our financial processes.

The comprehensive HBC 202, which is an AI/ML digital platform, empowers users to seamlessly associate utility payments 102c with specific payment methods, such as Card 101a or UPI 101b. This platform intelligently determines the appropriate payment instrument 101 based on predefined rules. For instance, if the payment amount is $500, a specific payment instrument (e.g., a credit card with a higher limit) will be automatically selected. Conversely, transactions below $10 require no additional authentication, such as a Personal Identification Number (PIN) or other validation. In a more stringent scenario, transactions surpassing $1000 necessitate both PIN and OTP verification for enhanced security and validation.

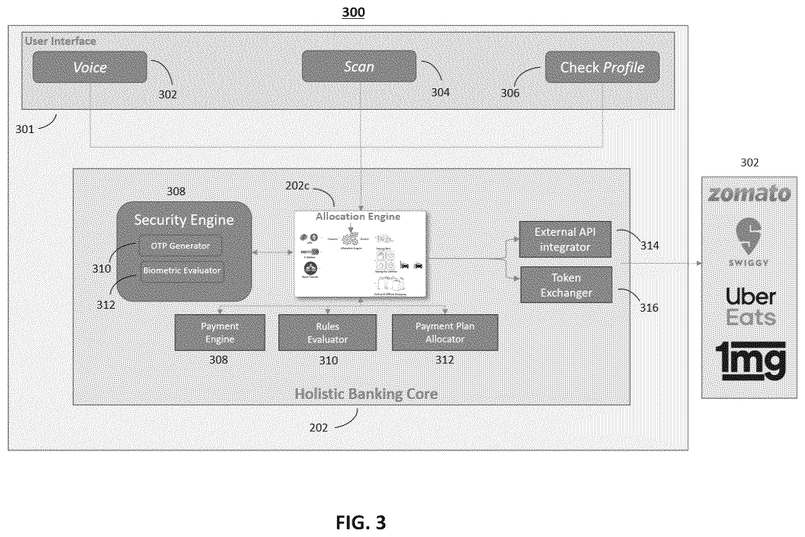

FIG. 3 illustrates an HLD view of an HDBP 300 that includes details of the HBC 202 depicted in FIG. 2. The HDBP 300 also includes a customer interface 301 that provides the customer an opportunity to interact with the HBC 202.

As an initial step, the customer may interact with the HBC 202 by voice via voice module 302. The interaction, for example, may be configured with a specific keyword to activate the system. Through the voice module 302, for example, the customer may issue an instruction to “pay rent,” “pay credit card bill,” or the like. After this initial interaction, the customer may dictate a payment action or scan a QR code via scan module 304 with the intent to make a purchase/payment.

In the HDBP 300, financial transactions may be governed by transaction rules created through encoding or programming within a check profile module 306, a rules evaluator 310, and/or a payment plan allocator 312, which interact with the check profile module 306 via the allocation engine 202c.

The HBC 202 also includes a security engine 308 to provide security validation for financial transactions. In various embodiments, the security engine 308 provides different levels of payment transaction security validation using, for example, an OTP generator 310 and a biometric evaluator 312. By way of example, the allocation engine 202c may receive instructions via the voice module 302 to check a profile via the check profile module 306, the rules evaluator 310, and/or payment plan allocator 312 for the correct rules to apply to a pending payment transaction.

In performing payment transaction security validation, the allocation engine 202c will interact with security engine 308 to validate the requested payment transaction profiles. As an example, the security engine 308 may activate a transaction security software routine within the security engine 308 before a payment transaction is initiated.

After completion of security validation within the security engine 308, the allocation engine 202c may commence the financial transactions process by interacting, in a holistic manner, with the respective external vendor APIs (discussed above) via an external API integrator 314 across all payment instrument financial institutions and payment instruments 101. The security engine 308 may then obtain a token for exchange with the payment instrument financial institutions and with the vendors via a token exchanger 316 to complete the financial transactions process.

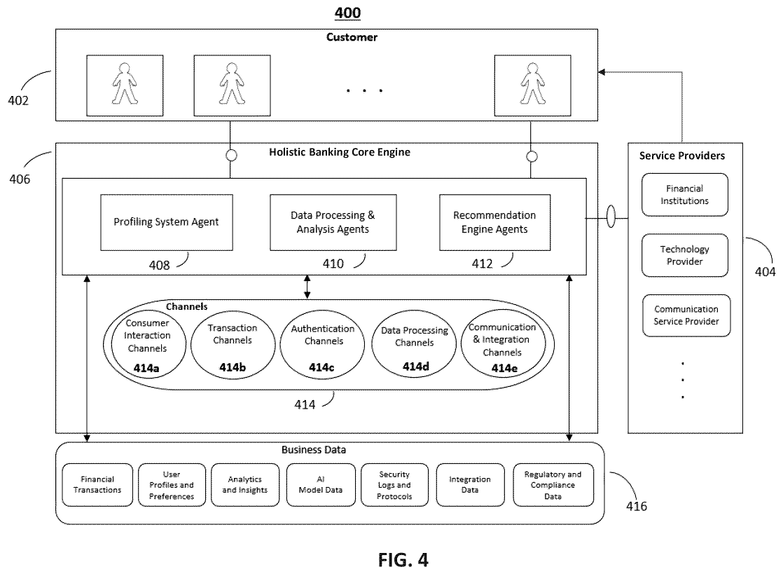

FIG. 4 illustrates a block diagram view of an exemplary HDBP ecosystem 400 within which the HDBP 300 of FIG. 3 may be implemented. The focus of the HDBP ecosystem 400 is to provide a convenient and simplified payment transaction experience for customers 402. Key platforms (e.g., financial, technology, communications, etc.) necessary for the operation of the embodiments are supplied by service providers 404. The HDBP ecosystem 400 incorporates real-time feedback loops, where user interactions (e.g., accepted/rejected recommendations, transaction history) inform adjustments to the profile. The service providers 404 can override or fine-tune profile parameters based on business objectives, compliance needs, or user-specific constraints.

The central component (e.g., core) of the HDBP ecosystem 400 is HBC engine 406. In the exemplary embodiment of FIG. 4, the HBC engine 406 includes three fundamental AI agent types: a profiling system agent 408, data processing & analysis agents 410, and recommendation engine agents 412. The embodiments, however, are not limited to or restricted to these three agent types.

In the HDBP ecosystem 400 of FIG. 4, for example, the profiling system agent 408 is responsible for the creation of customer profiles and preferences (Payment Rules). The customer profiles are created by large language models (LLMs) that provide AI-assisted profiling. By way of example, the profiling system agent 408 employs context-aware LLMs, pre-trained on structured and unstructured behavioral datasets, to predict preferences of the customers 402 with minimal input. Continuous learning is enabled via reinforcement mechanisms where LLM accuracy improves based on observed deviations between predicted and actual customer actions.

Within the HBC engine 406, the profiling system agent 408 functions as the central orchestrator, leveraging insights from data processing & analysis agents 410, which clean, aggregate, and derive behavioral patterns from raw customer data. These insights are then fed into the recommendation engine agents 412, which map user behaviors against predefined rules and dynamically refine the profile to enhance personalization for the customers 402. The data processing & analysis agents 410 manage analytics and AI model data, as well as security logs.

The recommendation engine agents 412 facilitate insights into data-driven suggestions related to past financial transactions. The profiling system agent 408, the data processing & analysis agents 410, and the recommendation engine agents 412 seamlessly communicate through various channels 414, including consumer interaction channels 414a, transaction channels 414b, authentication channels 414c, data processing channels 414d, and communication/integration channels 414e, etc. The various channels 414 facilitate feedback between the profiling system agent 408, the data processing & analytics agents 410, the recommendation agents 412 (within the HBC engine 406), and the service providers 404.

Also provided within the HDBP ecosystem 400 system is crucial stored business data 416 processed and analyzed within the profiling system agent 408, the data processing & analysis agents 410, and the recommendation engine agents 412. Business data 416 may include financial transactions, user profiles and preferences, analytics and insights, AI model data, and the like.

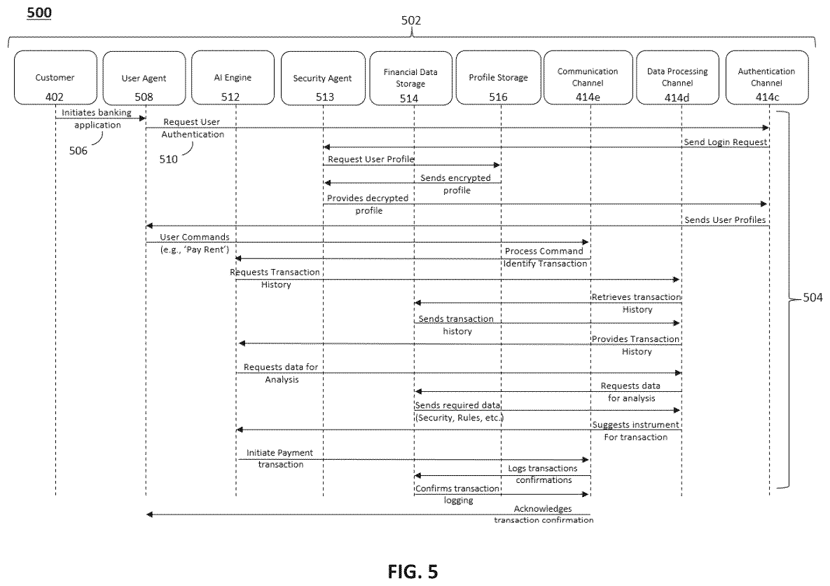

FIG. 5 illustrates a dynamic flow diagram 500, or execution paths, of transactions within the HDBP ecosystem 400 of FIG. 4 and the HDBP high-level architecture 200 of FIG. 2. The flow diagram 500 depicts execution modules 502 executing exemplary flow sequences 504 during the operation of the HDBP ecosystem 400. For example, during a payment transaction, an execution path within the HDBP ecosystem 400 may call on one or more of the execution modules 502 to perform one or more payment transaction processing features described above.

The exemplary flow diagram 500 commences with one of the customers 402 initiating payment via a banking application at block 506. User authentication is requested by the user agent 508 at block 510 as no other system access is permitted without first completing authentication.

Subsequently, other flow sequences within the dynamic flow diagram 500 show flows between, for example, a security agent 513, an AI engine 512, financial data storage 514, profile storage components 516 (and others) within the execution modules 502, communication channels 414 (FIG. 4) to exchange APIs. The dynamic flow diagram 500 also illustrates the sending and receiving of data and giving confirmation to complete the payment transaction. These steps represent an entire payment transaction process within the flow sequences 504.

By way of example only and not limitation, in one or more embodiments, the AI engine 512 is configured to record every payment transaction, perform analytics, and execute forecasting algorithms to be able to make predictions and provide options for the customer to optimize and simplify payment transactions. In the embodiments, the usual burden on the customer, such as deciding which card to use to complete a financial transaction, is transferred to a profile, thus enabling an application to replace that burden with AI-assisted automation.

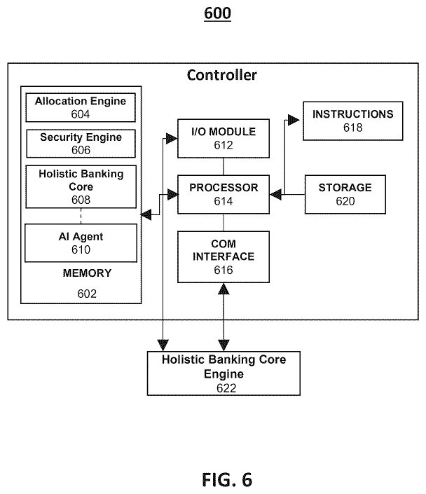

FIG. 6 illustrates an exemplary controller 600 that may be application-specific hardware, software, and firmware implementation of the exemplary HDBP architecture 200 in FIG. 2, described above. The embodiments are not limited to the computer architecture embodied within the controller 600. Other computer architectures that are well known to those of skill in the art, such as a modified Harvard architecture as one example, may be used and are within the spirit and scope of the present disclosure.

The controller 600 can include a processor 614 configured to execute one or more components of the HBC 202 of FIG. 2 or the functions of the exemplary HBC engine 406, described above.

The processor 614 can have a specific structure imparted to the processor 614 by instructions stored in memory 602 and/or by instructions 618 fetchable by the processor 614 from a storage medium 620. The storage medium 620 can be remote and communicatively coupled to the controller 600. Such communications can be encrypted.

The controller 600 can be a stand-alone programmable system, or a programmable module included in a larger system. For example, the controller 600 may include, or be connected with, the HDBP architecture 200. The controller 600 may include one or more hardware and/or software components configured to fetch, decode, execute, store, analyze, distribute, evaluate, and/or categorize information.

The processor 614 may also include one or more processing devices or cores (not shown). In some embodiments, the processor 614 may be a plurality of processors, each having either one or more cores. The processor 614 can execute instructions fetched from the memory 602 to perform the functionality of the allocation engine, the security engine, the holistic banking core, and/or the AI engine, respectively, stored in memory modules 604, 606, 608, or 610. Alternatively, the instructions can be fetched from the storage medium 620, or from a remote device connected to the controller 600 via a communication interface 616. Furthermore, the communication interface 616 can also interface with computer systems within a computer system of the HDBP architecture 200. An input/output (I/O) module 612 may be configured for additional communications to or from associated remote systems of a host 622 of the HDBP architecture 200.

Without loss of generality, the storage medium 620 and/or the memory 602 can include a volatile or non-volatile, magnetic, semiconductor, optical, removable, non-removable, read-only, random-access, or any type of non-transitory computer-readable computer medium. The storage medium 620 and/or the memory 602 may include programs and/or other information usable by processor 614. Furthermore, the storage medium 620 can be configured to log data processed, recorded, or collected during the operation of the controller 600.

The data may be time-stamped, location-stamped, cataloged, indexed, encrypted, and/or organized in a variety of ways consistent with data storage practice. By way of example, the memory module 608 can form the previously described HDBP architecture 200. The instructions embodied in these memory modules can cause the processor 614 to perform certain operations consistent with the functions described in FIG. 2 above.

Embodiments of the present disclosure provide at least the following advantages:
a) Digital Transformation: The world is rapidly shifting towards digital transactions due to convenience and technological advancements.
b) Increased Online Transactions: Online shopping, bill payments, and remote transactions have become commonplace, creating demand for secure and customer-friendly payment platforms.
c) Personalization Demand: Consumers seek tailored experiences in all aspects of their digital interactions, including payments.
d) Fintech Industry Growth: The global fintech market is experiencing rapid growth, driven by technological innovation, changing customer preferences, and increasing adoption of digital payments.
e) Customer-Centric Solutions: There's a significant demand for solutions that put customers in control of their payment experiences, enhancing their overall financial management.
f) Security-Enhanced Platforms: Solutions offering advanced security features, like multi-factor authentication and biometric verification, are gaining traction due to rising concerns about cyber threats.
g) Convenience and Efficiency: Applications that simplify payment processes, automate fund allocation, and enhance the customer experience are gaining popularity.
h) Customization and Flexibility: The ability to customize payment methods and authentication preferences aligns with the trend of personalized digital experiences.
i) Mobile Banking and Payment Apps: Collaborate with banks to integrate your solution as a value-added service to their existing mobile banking apps. Partner with e-commerce platforms to offer a secure, seamless, and personalized payment experience for their customers.
j) Bill Payment Services: Address the increasing need for convenient bill payment platforms that incorporate advanced security measures.
k) Cross-Border Transactions: Expand into cross-border transactions, targeting travelers, freelancers, and businesses that require efficient and secure international payments.
l) Business-to-business (B2B) transactions: Offer a tailored solution for businesses to manage payments between suppliers, clients, and employees, enhancing transparency and security

Purely for explanatory purposes, the following example use cases are provided.

Use Case 1 (Enhanced Security Through Multi-Factor Authentication). Imagine a customer, Ms. X, a busy professional paying rent and utility bills and occasionally shopping offline. With the application's profile creation feature described above, Ms. X can effortlessly streamline her payment preferences. She may set up distinct profiles for various transaction types.

For rent, she may designate bank transfers as the default payment method. For utility bills, she may opt for automatic payment through his credit card. For her occasional offline shopping, Ms. X presets her debit card. The application ensures that these preferences are automatically applied when Ms. X initiates transactions, saving her time and reducing the chances of choosing the wrong payment method. It's like having a personal payment assistant, ensuring that each payment is made with the right method without Ms. X lifting a finger.

Use Case 2 (Enhanced Security Through Multi-Factor Authentication). In use case 2, Mr. Y is a security-conscious individual. He's concerned about the safety of his financial transactions. In the embodiments, Mr. Y is provided peace of mind by allowing him to create custom multi-factor authentication profiles. For transactions below a certain threshold (e.g., $10,000), the exemplary HDBP architecture 200 authenticates on auto-generated OTP. However, for larger transactions exceeding the threshold of $10,000, the system demands both an OTP and a fingerprint scan. Mr. Y can even set unique combinations, such as a fingerprint scan followed by facial recognition. With these dynamic security options, Mr. Y's financial data remains incredibly secure.

Use Case 3 (Smart Cash Management and Investment). Consider Ms. Z's desire to optimize her investments. The embodiments employ the powerful allocation engine 202c that continuously monitors her account balances and transaction history. It suggests optimizing her idle cash, recommending the right account or E-wallet to park her money, and ensuring she gains the maximum benefit from interest rates or investment opportunities. Moreover, the allocation engine identifies the ideal moments to use specific accounts or cards to take full advantage of ongoing promotions and offers, such as using a credit card with travel rewards for booking flights or hotels.

In the embodiments, and by way of review, the DPAE intelligently selects the most suitable payment method based on real-time limits, transaction preferences, and available funds. For larger transactions, the DPAE suggests an optimal distribution strategy across the customer's designated payment methods to ensure successful payments.

When initiating a payment, the embodiments identify the relevant profile based on the transaction type. With a simple voice command, transactions can be executed. For example, when the customer says “Pay Rent, the” system authenticates the customer using voice authentication, visits the customer's rent payment profiles, and pays the rent based on rules the customer has set. With enhancements to multi-factor authentication, voice recognition, OTP generation, and biometric authentication can be integrated within a single transaction authentication process. This process ensures secure access and transaction initiation.

Using one or more exemplary embodiments, customers may interact with an intuitive and customer-friendly interface for profile creation, rule-setting, and transaction initiation. For example, customers may initiate transactions by selecting the relevant profile (voice authenticated). The embodiments guide customers through the multi-factor authentication process, ensuring secure verification. The DPAE's decision is presented to the customer before confirming the transaction. Once the customer's identity is authenticated and the optimal payment method is determined by the DPAE, the transaction is processed.

Customers can easily manage their payment preferences, eliminating confusion and enhancing usability. By improving the end customers' overall experience, adoption rates, and customer satisfaction correspondingly increase.

Additional end-user benefits include tailored payment experiences. For example, customers can create unique payment profiles for various transactions, customizing payment methods and authentication preferences. Personalized rules ensure a seamless and convenient payment process that aligns with individual preferences and needs. The application adapts to customers, enhancing satisfaction and engagement.

Another benefit is advanced security and trust. Customers can confidently conduct transactions knowing their identity is well-protected against unauthorized access and fraud. For example, the customer establishes in a profile if a transaction may read the OTP automatically or if the transaction needs OTP entry manually. In yet another option, the transaction may require completion with OTP+biometric authentication.

The DPAE provides efficient funds management. That is, the DPAE optimizes fund distribution across various payment methods based on transaction requirements. As a result, the customer benefits from efficient allocation that maximizes transaction success rates and minimizes the risk of declined payments. The DPAE also provides simplified large transactions to streamline fund management, ensuring optimal use of available resources.

Comparatively large transactions are simplified. The DPAE simplifies the complexities of large transactions by automatically distributing funds. Customers no longer need to manually check various accounts and limits, reducing effort and saving time. The streamlined large transactions ensure hassle-free payments for significant purchases.

Flexibility and control are also optimized. That is, customers have complete control over their payment profiles and preferences, enabling them to adapt to changing needs. Flexibility in payment methods and authentication options allows customers to tailor the application to their evolving requirements. The solutions provided by the embodiments power customers with the ability to manage their finances according to their preferences.

The allocation engine's automatic distribution of funds for large transactions based on predefined rules is a novel solution to simplify and optimize fund management for significant purchases. Transactions are evaluated in real time. Specifically, the real-time evaluation of transaction requirements, available funds, and payment rules optimizes decision-making during payment initiation and enhances efficiency.

A seamless interface for profile management provides an intuitive and customer-friendly interface for customers. This seamless interface enables customers to create profiles, set rules, and manage their payment preferences and enhances customer experience through an innovative user interface user experience (UI/UX) design. The combination of multi-factor authentication, dynamic fund allocation, and real-time transaction monitoring introduces a layered security and fraud approach for digital transactions.

This proposed payment profile management system seamlessly merges intelligent agents and engines on a computer or cloud infrastructure. Users initiate future payments through a gateway manager, triggering a dynamic process powered by an ensemble of cutting-edge components.

At its core, the Allocation Engine intelligently evaluates transaction requirements, user preferences, and available funds to select optimal payment methods. This aligns seamlessly with the method of implementation, responding to user requests and dynamically optimizing payment methods based on sophisticated analyses.

The Data Processing and Analysis Agent mines patterns from stored transactions, establishing associations between payment types and vendors. These insights, coupled with Recommendation Engine Agents, ensure proactive suggestions align with user behavior, setting a new standard for personalized financial management.

Security is fortified by the dynamic Security Engine, employing multifactor authentication. Transaction validation varies based on user-defined methods and adapts dynamically to transaction amounts, adding an extra layer of protection.

Empowering users, the Profiling System Agent enables the creation of intricate payment profiles. Users customize rules, authentication methods, and security levels for various transactions, achieving unparalleled personalization and control.

This integrated system transcends traditional payment approaches, seamlessly aligning with user-initiated requests, dynamically optimizing payment methods, and setting the stage for secure, efficient, and personalized financial interactions.

The embodiments enable users to create highly customized payment profiles, comprising rules for selecting payment methods based on transaction attributes such as type, monetary value, vendor classification, transaction frequency, geolocation, and temporal parameters, where said profiles are stored securely and dynamically adaptable to user preferences.

The embodiments also provide a mechanism allowing users to configure complex, multi-tiered authentication preferences, including but not limited to biometric verification (e.g., fingerprint, facial recognition, voice recognition), OTPs, multi-factor authentication (MFA), dynamic security tokens, and context-aware authentication protocols tailored to varying transaction risk levels and compliance with jurisdictional security mandates.

A robust feature is provided for managing multiple, concurrent user profiles within the application, with granular control over individualized payment rules, authentication preferences, transaction limits, spending categories, and specific account access permissions, ensuring secure multi-user environments for both personal and enterprise use cases.

The embodiments also provide AI-driven transaction intelligence and decision optimization. An advanced AI-powered allocation engine capable of autonomously analyzing multi-dimensional user data, including behavioral patterns, historical transaction data, contextual metadata, and real-time financial market conditions, to intelligently recommend the most optimal payment instruments for each transaction while continuously learning from transactional feedback loops.

A sophisticated pattern recognition system is integrated with a deep learning algorithms that continuously monitors and identifies evolving user spending habits, predicts future transactional behaviors, and dynamically adjusts payment routing strategies to enhance cost-efficiency, security, and user satisfaction.

Although the present application describes specific embodiments that may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A dynamic payment allocation method for initiating future payment transactions, comprising:
receiving, via a gateway manager, requests from the user to make current payments to a plurality of vendor payment platforms in accordance with the behavior of the user;
using AI, via an allocation engine, to dynamically evaluate the received requests, analyze the user's behavior, and recognize patterns responsive to the evaluation and analysis; and
automatically selecting an optimal one of the plurality vendor payment platforms for future payments by the user in accordance with the evaluation, the analysis, and the recognized patterns.

2. The method of claim 1, wherein the behavior relates to at least one of selecting payment methods and selecting authentication methods.

3. The method of claim 2, wherein the payment methods include at least one of credit cards, e-wallets, bank transfers, and unified payment interfaces.

4. The method of claim 2, further comprising a security engine, the security engine configured to implement the authentication methods, dynamically adjust the authentication methods based on user-defined preferences, vary security levels, and adapt to transaction amounts;
wherein the security methods include at least one of multifactor authentication, voice modulation recognition, and a one-time password.

5. The method of claim 1, wherein the gateway manager securely receives the requests from the user.

6. The method of claim 5, further comprising analyzing, via an intelligent data processing and analysis system, stored previous transactions associated with the user.

7. The method of claim 6, further comprising analyzing stored previous transactions associated with the user and identifying patterns for associating payment transaction types with different vendors.

8. The method of claim 7, further comprising creating, via a profiling system agent, personalized payment profiles.

9. The method of claim 8, further comprising executing transactions via a payment engine configured to operate in conjunction with a rules evaluator engine.

10. A banking system for initiating future payments from a user to a vendor, comprising:
a gateway manager configured for receiving requests from the user to make current payments to a plurality of vendor payment platforms in accordance with the behavior of the user; and
an allocation engine configured to use artificial intelligence (AI) to dynamically evaluate the received requests, analyze the user's behavior, and recognize patterns responsive to the evaluation and analysis;
wherein an optimal one of the plurality vendor payment platforms is automatically selected for future payments by the user in accordance with the evaluation, the analysis, and the recognized patterns.

11. The banking system of claim 10, wherein the behavior relates to at least one of selecting payment methods and selecting authentication methods.

12. The banking system of claim 11, wherein the payment methods include at least one of credit cards, e-wallets, bank transfers, and unified payment interfaces.

13. The banking system of claim 12, further comprising a security engine, the security engine configured to implement the authentication methods, dynamically adjust the authentication methods based on user-defined preferences, vary security levels, and adapt to transaction amounts;
wherein the security methods include at least one of multifactor authentication, voice modulation recognition, and a one-time password.

14. The banking system of claim 10, wherein the gateway manager securely receives the requests from the user.

15. The banking system of claim 14, further comprising an intelligent data processing and analysis system.

16. The banking system of claim 15, wherein the intelligent data processing and analysis system includes a data processing and analysis agent configured for analyzing stored previous transactions associated with the user, and identifying patterns associating payment transaction types with different vendors.

17. A system for profiling payment transactions between a user and selected service provider platforms, the system comprising:
an analytics agent configured to derive user transaction patterns from received user data;
a profiling agent configured to create user payment profiles based on the transaction patterns; and
a recommendation agent for dynamically enhancing the user payment profiles based on suggestions related to the received user data.

18. The system of claim 17, wherein the profiling agent includes large language models (LLMs) pre-trained on structured and unstructured datasets.

19. A non-transitory computer-readable medium having instructions stored thereon on, the instructions, when executed, cause a processor to perform a method comprising:
receiving, via a gateway manager, requests from a user to make current payments to a plurality of vendor payment platforms in accordance with the behavior of the user;
using AI, via an allocation engine, to dynamically evaluate the received requests, analyze the user's behavior, and recognize patterns responsive to the evaluation and analysis; and
automatically selecting an optimal one of the plurality vendor payment platforms for future payments by the user in accordance with the evaluation, the analysis, and the recognized patterns.

20. The non-transitory computer-readable medium of claim 19, wherein the behavior relates to at least one of selecting payment methods and selecting authentication methods.
